(19) United States
(12) Patent Application Publication
(10) Pub. No.: US 2026/0117852 A1
(43) Pub. Date: Apr. 30, 2026

(54) ROLLING GEAR RACK MECHANISM WITH TOOTH PROFILE HAVING HYPERBOLIC TOOTH LINE STRUCTURE BASED ON A PARABOLIC FUNCTION

(71) Applicant: Guangdong Ocean University, Zhanjiang (CN)

(72) Inventors: Zhen CHEN, Zhanjiang (CN); Junjie LI, Zhanjiang (CN); Hui YANG, Zhanjiang (CN); Xiaoping XIAO, Zhanjiang (CN); Chao HE, Zhanjiang (CN); Wanhe TANG, Zhanjiang (CN)

(21) Appl. No.: 19/433,053

(22) Filed: Dec. 25, 2025

Related U.S. Application Data
(63) Continuation of application No. PCT/CN2025/124780, filed on Sep. 28, 2025.

(30) Foreign Application Priority Data
Sep. 30, 2024 (CN) 202411380614.7

(51) Int. Cl. F16H 55/08; F16H 55/26

(52) U.S. Cl. CPC F16H 55/088; F16H 55/0806; F16H 55/0886; F16H 55/26

(57) ABSTRACT

A rolling gear rack mechanism with tooth profile having hyperbolic tooth line structure based on a parabolic function includes a gear and a rack. An end face tooth profile of the gear and an end face tooth profile of the rack are composed of an end face working tooth profile curve and a tooth root transition curve, and the end face tooth profile of the gear and the end face tooth profile of rack are both symmetrical left and right. The end face working tooth profile curve of the gear and the end face working tooth profile curve of the rack are parabolic, and a tooth surface of the gear and a tooth surface of the rack have a hyperbolic tooth line structure. At least one pair of gear teeth meshing points of the gear and the rack are located at nodes to achieve rolling meshing contact.

### CROSS-REFERENCE TO RELATED APPLICATION

This application is a Bypass Continuation Application of PCT/CN2025/124780 filed on Sep. 28, 2025, which claims priority to Chinese Patent Application No. 202411380614.7 filed on Sep. 30, 2024, which are incorporated herein by reference in their entirety.

### TECHNICAL FIELD

The present disclosure relates to the technical field of gear transmission, and particularly to a rolling gear rack mechanism with tooth profile having hyperbolic tooth line structure based on a parabolic function.

### BACKGROUND

Traditional involute gears are widely used in various mechanical equipment, especially in high-speed and high-load transmission scenarios, including industrial equipment such as automobile transmission systems, automobile gearboxes, marine engines and machine tool headboxes. The main function of gears is to transmit motion and power.

For example, the Chinese patent with application No. 201710016238.7 discloses “a concave-convex meshing circular arc gear rack mechanism without relative sliding,” and the Chinese patent with application No. 201710016207.1 discloses “a convex-concave meshing circular arc gear rack mechanism without relative sliding”. The tooth profiles of the above-mentioned gears and racks are all arc-shaped tooth profiles. The tooth surfaces of the gears and racks slide relatively large during meshing transmission, causing problems such as friction and wear, gluing and plastic deformation, which are difficult to meet the precision transmission requirements of high-end equipment. In addition, due to the heat and noise generated by sliding friction, gears and racks also have higher requirements for the working environment and equipment maintenance.

### SUMMARY

According to various embodiments, in order to solve the problems of large relative sliding of tooth surfaces and severe friction and wear in gear rack mechanisms of existing gear transmission technology, embodiments of the present disclosure provide a rolling gear rack mechanism with tooth profile having hyperbolic tooth line structure based on a parabolic function.

In some embodiments, a rolling gear rack mechanism with tooth profile having hyperbolic tooth line structure based on a parabolic function includes a gear and a rack. An end face tooth profile of the gear and an end face tooth profile of the rack are composed of an end face working tooth profile curve and a tooth root transition curve, and the end face tooth profile of the gear and the end face tooth profile of rack are both symmetrical left and right. The end face working tooth profile curve of the gear and the end face working tooth profile curve of the rack are parabolic, and a tooth surface of the gear and a tooth surface of the rack have a hyperbolic tooth line structure. At least one pair of gear teeth meshing points of the gear and the rack are located at nodes to achieve rolling meshing contact, and a meshing line formed by moving trajectories of the meshing points of the gear and the rack forms a gear contact line and a rack contact line on the tooth surface of the gear and the tooth surface of the rack respectively.

In some embodiments, the gear contact line is a curve having a hyperbolic line shape after being unfolded along a pitch cylinder, and the rack contact line is a curve having a hyperbolic line shape after being unfolded along a pitch plane. The tooth surface of the gear is formed by regular sweeping of the end face tooth profile of the gear along the gear contact line, and the tooth surface of the rack is formed by regular sweeping of the end face tooth profile of the rack along the rack contact line.

In some embodiments, the working tooth profile curve on the right side of the gear and the working tooth profile curve on the right side of the rack are both formed by parabolas, and the tooth root transition curve is composed of a Hermite curve. A value range of the end face working tooth profile curve is to control a starting point and an ending point of the working tooth profile curve according to specific control points. A tooth top control point of the gear is determined by an intersection point of a tooth top circle and a parabolic curve, a starting control point of the tooth root transition curve is determined by an intersection point P_{G4} of the parabolic curve and a tooth root transition starting circle, and a contact control point of the tooth root transition curve is determined by an intersection point P_{G3} of a tooth root circle and an oblique line passing through the point P_{G4} with a slope of 1. The points P_{G4} and P_{G3} are connected according to a Hermite curve equation to form a tooth root curve.

In some embodiments, the gear contact line and the rack contact line are determined.

Four spatial coordinate systems O₀-x₀, y₀, z₀, Oₖ-xₖ, yₖ, zₖ, O₁-x₁, y₁, z₁ and O₂-x₂, y₂, z₂, are established. A z₀ axis and a z axis coincide with a rotary axis of the gear, a zₖ axis coincides with the meshing line of the gear and the meshing line of the rack, a z₂ axis is on the rack and is at a distance of φ₁R₁ from the zₖ axis, and distance between the zₖ axis and the z₀ axis is R₁. The coordinate system O₀-x₀, y₀, z₀ is fixedly connected to the gear, and the coordinate system O₂-x₂, y₂, z₂ is fixedly connected to the rack. The gear rotates around the z₀ axis at a uniform angular velocity ω₁, and the rack moves along a y₂ axis at a uniform linear velocity v₁. After a period of time from a starting position, the coordinate system O₀-x₀, y₀, z₀ rotates with the gear around the z₀ axis, and the coordinate system O₂-x₂, y₂, z₂ moves with the rack along the y₂ axis.

In the coordinate system Oₖ-xₖ, yₖ, zₖ, a parametric equation of the meshing line of the meshing point motion of the gear and the rack is set as:

$$\{ \begin{matrix}{x}_{k} = 0 \\ {y}_{k} = 0 \\ {z}_{k} = \pm b \sqrt{{( \frac{x}{Δ x} + 1 + \sqrt{2} )}^{2} / {( 1 + \sqrt{2} )}^{2} - 1} , 0 \leq x \leq Δ x\end{matrix} \qquad ( 1 )$$

The relationship between a rotation angle of the gear and a motion of the rack is:

$$\{ \begin{matrix}{φ}_{1} = {k}_{φ} x \\ {v}_{2} = {ω}_{1} {R}_{1}\end{matrix} \qquad ( 2 )$$

When the meshing points move along the meshing line, the gear contact line and the rack contact line are formed on the tooth surface of the gear and the tooth surface of the rack, respectively. According to the principle of coordinate transformation, the coordinate transformation matrix for forming the three spatial coordinate systems O₀-x₀, y₀, z₀, O₁-x₁, y₁, z₁ and O₂-x₂, y₂, z₂ is:

$${M}_{1 k} = {M}_{10} \times {M}_{0 k} \qquad ( 3 )$$

In the matrix:

$${M}_{2 k} = [ \begin{matrix}1 & 0 & 0 & 0 \\ 0 & 1 & 0 & - {φ}_{1} {R}_{1} \\ 0 & 0 & 1 & 0 \\ 0 & 0 & 0 & 1\end{matrix} ] \qquad ( 4 )$$

$${M}_{10} = [ \begin{matrix}cos {φ}_{1} & - sin {φ}_{1} & 0 & 0 \\ sin {φ}_{1} & cos {φ}_{1} & 0 & 0 \\ 0 & 0 & 1 & 0 \\ 0 & 0 & 0 & 1\end{matrix} ] \qquad ( 5 )$$

$${M}_{0 k} = [ \begin{matrix}1 & 0 & 0 & {R}_{1} \\ 0 & 1 & 0 & 0 \\ 0 & 0 & 1 & 0 \\ 0 & 0 & 0 & 1\end{matrix} ] \qquad ( 6 )$$

In equations (4) and (6), R₁ is a pitch circle radius of the gear, and φ₁ is a rotation angle of the gear.

A parametric equation of the gear contact line of the tooth surface of the gear is obtained from equations (1) and (5) as follows:

$$\{ \begin{matrix}{x}_{1} = {R}_{1} cos {φ}_{1} \\ {y}_{1} = {R}_{1} sin {φ}_{1} \\ {z}_{1} = {z}_{k} ( x )\end{matrix} \qquad ( 7 )$$

A parametric equation of the rack contact line of the tooth surface of the rack is obtained from equations (1) and (4) as follows:

$$\{ \begin{matrix}{x}_{1} = 0 \\ {y}_{1} = - {φ}_{1} {R}_{1} \\ {z}_{1} = {z}_{k} ( x )\end{matrix} \qquad ( 8 )$$

In some embodiments, the end face tooth profile of the gear and the end face tooth profile of the rack are determined.

In the coordinate system Oₖ-xₖ, yₖ, zₖ, the working tooth profile on the right side of the gear is determined by a parametric equation (9):

$$\{ \begin{matrix}{x}_{k}^{l 1 r} = t cos {α}_{t} + {pt}^{2} sin {α}_{t} \\ {y}_{k}^{l 1 r} = t sin {α}_{t} - {pt}^{2} cos {α}_{t} \\ {z}_{k}^{l 1 r} = 0\end{matrix} \qquad ( 9 )$$

In the coordinate system Oₖ-xₖ, yₖ, zₖ, the working tooth profile on the right side of the rack is determined by a parametric equation (10):

$$\{ \begin{matrix}{x}_{k}^{l 2 r} = t cos {α}_{t} - {pt}^{2} sin {α}_{t} \\ {y}_{k}^{l 2 r} = t sin {α}_{t} + {pt}^{2} cos {α}_{t} \\ {z}_{k}^{l 2 r} = 0\end{matrix} \qquad ( 10 )$$

In the coordinate system Oₖ-xₖ, yₖ, zₖ, the working tooth profile on the left side of the rack is determined by a parametric equation (11):

$$\{ \begin{matrix}{x}_{k}^{l 2 l} = t cos {α}_{t} - p {t}^{2} sin {α}_{t} \\ {y}_{k}^{l 2 l} = - t sin {α}_{t} - p {t}^{2} cos {α}_{t} + \frac{{R}_{1} π}{{Z}_{2}} \\ {z}_{k}^{l 2 l} = 0\end{matrix} \qquad ( 11 )$$

In the coordinate system O₁-x₁, y₁, z₁, the working tooth profile on the right side of the gear is determined by a parametric equation (12):

$$\{ \begin{matrix}{x}_{1}^{l 1 r} = t cos {α}_{t} + {pt}^{2} sin {α}_{t} + {R}_{1} \\ {y}_{1}^{l 1 r} = t sin {α}_{t} - {pt}^{2} cos {α}_{t} \\ {z}_{1}^{l 1 r} = 0\end{matrix} \qquad ( 12 )$$

In the coordinate system O₁-x₁, y₁, z₁, the working tooth profile on the left side of the gear is determined by a parametric equation (13):

$$\{ \begin{matrix}{x}_{1}^{l 1 l} = cos \frac{π}{{Z}_{1}} {x}_{1}^{l 1 r} + sin \frac{π}{{Z}_{1}} {y}_{1}^{l 1 r} \\ {y}_{1}^{l 1 l} = sin \frac{π}{{Z}_{1}} {x}_{1}^{l 1 r} - cos \frac{π}{{Z}_{1}} {y}_{1}^{l 1 r} \\ {z}_{1}^{l 1 l} = 0\end{matrix} \qquad ( 13 )$$

In some embodiments, the tooth surface of the gear and the tooth surface of the rack are determined.

The tooth surface of the gear is formed by regular sweeping along the meshing point M. The working tooth surface on the left side of the gear is determined by a parametric equation (14):

$$\{ \begin{matrix}{X}_{1}^{l 1 l} = {x}_{1}^{l 1 l} cos ( {k}_{φ} x ) - {y}_{1}^{l 1 l} sin ( {k}_{φ} x ) \\ {Y}_{1}^{l 1 l} = {x}_{1}^{l 1 l} sin ( {k}_{φ} x ) + {y}_{1}^{l 1 l} cos ( {k}_{φ} x ) \\ {Z}_{1}^{l 1 l} = \pm b \sqrt{{( \frac{x}{Δ x} + 1 + \sqrt{2} )}^{2} / {( 1 + \sqrt{2} )}^{2} - 1}\end{matrix} \qquad ( 14 )$$

The working tooth surface on the right side of the gear is determined by a parametric equation (15):

$$\{ \begin{matrix}{X}_{1}^{l 1 l} = {x}_{1}^{l 1 r} cos ( {k}_{φ} x ) - {y}_{1}^{l 1 r} sin ( {k}_{φ} x ) \\ {Y}_{1}^{l 1 r} = {x}_{1}^{l 1 r} sin ( {k}_{φ} x ) + {y}_{1}^{l 1 r} cos ( {k}_{φ} x ) \\ {Z}_{1}^{l 1 r} = \pm b \sqrt{{( \frac{x}{Δ x} + 1 + \sqrt{2} )}^{2} / {( 1 + \sqrt{2} )}^{2} - 1}\end{matrix} \qquad ( 15 )$$

The tooth surface of the rack is formed by along moving trajectories of the rack contact line. The working tooth surface on the left side of the rack is determined by a parametric equation (16):

$$\{ \begin{matrix}{X}_{2}^{l 2 l} = {x}_{k}^{l 2 l} \\ {Y}_{2}^{l 2 l} = {y}_{k}^{l 2 l} - {R}_{1} ( {k}_{φ} x ) \\ {Z}_{2}^{l 2 l} = \pm b \sqrt{{( \frac{x}{Δ x} + 1 + \sqrt{2} )}^{2} / {( 1 + \sqrt{2} )}^{2} - 1}\end{matrix} \qquad ( 16 )$$

The working tooth surface on the right side of the rack is determined by a parametric equation (17):

$$\{ \begin{matrix}{X}_{2}^{l 2 r} = {x}_{k}^{l 2 r} \\ {Y}_{2}^{l 2 r} = {y}_{k}^{l 2 r} - {R}_{1} ( {k}_{φ} x ) \\ {Z}_{2}^{l 2 r} = \pm b \sqrt{{( \frac{x}{Δ x} + 1 + \sqrt{2} )}^{2} / {( 1 + \sqrt{2} )}^{2} - 1}\end{matrix} \qquad ( 17 )$$

In some embodiments, the tooth root transition curve of the gear and the tooth root transition curve of the rack are determined.

The tooth root on the right side of the end face of the gear uses a Hermite curve as the transition curve. The Hermite curve is determined by points P_{F3} and P_{F4}, as well as T_{F3} and T_{F4}, which are the tangent vectors of points P_{F3} and P_{F4}, respectively. The point P_{F3} is determined by the working tooth profile curve on the right side of the gear and a starting radius Rₕ₁ of a tooth root transition fillet, and the point P_{F4} is determined by a radius R_{f1} of the tooth root circle and an oblique line passing through the point P_{F3} with a slope of 1. The parametric equation for the Hermite curve is:

$$\{ \begin{matrix}{x}_{P 34}^{her} = {b}_{1} {x}_{p} ( {P}_{F 3} ) + {b}_{2} {x}_{p} ( {P}_{F 4} ) + {T}_{H} {m}_{t} [ {b}_{3} {x}_{p} ( {T}_{F 3} ) + {b}_{4} {x}_{p} ( {T}_{F 4} ) ] \\ {y}_{P 34}^{her} = {b}_{1} {y}_{p} ( {P}_{F 3} ) + {b}_{2} {y}_{p} ( {P}_{F 4} ) + {T}_{H} {m}_{t} [ {b}_{3} {y}_{p} ( {T}_{F 3} ) + {b}_{4} {y}_{p} ( {T}_{F 4} ) ] \\ {z}_{P 34}^{her} = {b}_{1} {z}_{p} ( {P}_{F 3} ) + {b}_{2} {z}_{p} ( {P}_{F 4} ) + {T}_{H} {m}_{t} [ {b}_{3} {z}_{p} ( {T}_{F 3} ) + {b}_{4} {z}_{p} ( {T}_{F 4} ) ]\end{matrix} \qquad ( 18 )$$

The tooth root on the right side of the end face of the rack uses a Hermite curve as the transition curve. The Hermite curve is determined by points P_{G3} and P_{G4}, as well as T_{G3} and T_{G4}, which are the tangent vectors of points P_{G3} and P_{G4}, respectively. The point P_{G3} is determined by the working tooth profile curve on the right side of the gear and a starting radius Rₕ₂ of a tooth root transition fillet, and the point P_{G4} is determined by a radius R_{f2} of the tooth root circle and an oblique line passing through the point P_{G3} with a slope of 1. The parametric equation for the Hermite curve is:

$$\{ \begin{matrix}{x}_{G 34}^{her} = {b}_{1} {x}_{G} ( {P}_{G 3} ) + {b}_{2} {x}_{G} ( {P}_{G 4} ) + {T}_{H} {m}_{t} [ {b}_{3} {x}_{G} ( {T}_{G 3} ) + {b}_{4} {x}_{G} ( {T}_{G 4} ) ] \\ {y}_{G 34}^{her} = {b}_{1} {y}_{G} ( {P}_{G 3} ) + {b}_{2} {y}_{G} ( {P}_{G 4} ) + {T}_{H} {m}_{t} [ {b}_{3} {y}_{G} ( {T}_{G 3} ) + {b}_{4} {y}_{G} ( {T}_{G 4} ) ] \\ {z}_{G 34}^{her} = {b}_{1} {z}_{G} ( {P}_{G 3} ) + {b}_{2} {z}_{G} ( {P}_{G 4} ) + {T}_{H} {m}_{t} [ {b}_{3} {z}_{G} ( {T}_{G 3} ) + {b}_{4} {z}_{G} ( {T}_{G 4} ) ]\end{matrix} \qquad ( 19 )$$

In the parametric equation:

$$\{ \begin{matrix}{b}_{1} = 2 {t}_{H}^{3} - 3 {t}_{H}^{2} + 1 \\ {b}_{2} = - 2 {t}_{H}^{3} + 3 {t}_{H}^{2} \\ {b}_{3} = {t}_{H}^{3} - 2 {t}_{H}^{2} + {T}_{H} \\ {b}_{4} = {t}_{H}^{3} - {t}_{H}^{2}\end{matrix} \qquad ( 20 )$$

The present disclosure provides a rolling gear rack mechanism with tooth profile having hyperbolic tooth line structure based on a parabolic function. By using an active design method based on the parameter equation of the meshing line, the meshing points are arranged at the nodes, and the meshing line is constructed based on the motion law of the meshing point; the gear contact line becomes a hyperbola after unfolding on the pitch cylinder, and the rack contact line is a hyperbola at the pitch plane of the rack. After the gear contact line is unfolded on the pitch cylinder, it becomes an axisymmetric hyperbola to eliminate axial force. The theoretical value of the relative sliding speed of all meshing points on the gear contact line is zero, and the tooth surface of the tooth profile is a meshing tooth surface without relative sliding. Through the tooth profile with a hyperbolic tooth line structure, friction loss and noise are significantly reduced, transmission efficiency is greatly improved, failure forms such as tooth surface wear and plastic deformation are reduced, thereby extending the life of the transmission system.

The tooth profile of the gear and the tooth profile of the rack are both tooth profiles established based on a parabolic function, and the tooth root of the gear and the tooth root of the rack use a Hermite curve to enhance the bending strength of the tooth root, thereby making the gear less likely to break at the tooth root and enhancing the service life of the gear and rack.

The contact ratio of a gear can be freely designed, and the structural shape of the tooth profile can be determined by setting the contact ratio value, to evenly distribute the load and improve dynamic characteristics.

### BRIEF DESCRIPTION OF THE DRAWINGS

FIG. 1 is a schematic diagram of a rolling gear rack mechanism with tooth profile having hyperbolic tooth line structure based on a parabolic function in Embodiment 1 of the present disclosure.

FIG. 2 is a schematic diagram of a spatial meshing coordinate system of the rolling gear rack mechanism with tooth profile having hyperbolic tooth line structure based on a parabolic function in Embodiment 1.

FIG. 3 is a schematic diagram of an end face of the rolling gear rack mechanism with tooth profile having hyperbolic tooth line structure based on a parabolic function in Embodiment 1.

FIG. 4 is a schematic diagram of a tooth profile of a gear and a tooth profile of a rack in at Embodiment 1.

FIG. 5 is a schematic diagram of the gear in Embodiment 1.

FIG. 6 is a schematic diagram of the rack in Embodiment 1.

FIG. 7 is a schematic diagram of another rolling gear rack mechanism with tooth profile having hyperbolic tooth line structure based on a parabolic function in Embodiment 2.

Reference numerals and denotations thereof: 1—driver; 2—input shaft; 3—coupling; 4—output shaft; 5—gear; 6—rack; 7—meshing line; 8—pitch cylinder; 9—rack pitch plane; 10—gear contact line; 11—rack contact line; 12—tooth root transition curve; and 13—working tooth profile curve of end face.

### DETAILED DESCRIPTION

To make the purposes, technical solutions and advantages of the present disclosure clearer, embodiments of the present disclosure will be further described below with reference to the accompanying drawings. The following describes a preferred one of many possible embodiments of the present disclosure and is intended to provide a basic understanding of the present disclosure, but not to identify key or critical elements of the present disclosure or to limit the scope of protection.

In all examples shown and discussed herein, any specific values are to be interpreted as exemplary only and not as limiting. Therefore, other examples of exemplary embodiments may have different values.

Techniques, methods and equipment known to those of ordinary skill in the relevant art may not be discussed in detail, but where appropriate, such techniques, methods and equipment are to be considered part of the specification.

It is noted that similar numerals and letters indicate similar items in the following drawings. Therefore, once an item is defined in one figure, no further discussion of it is required in subsequent figures. At the same time, it will be understood that for ease of description, the size of various parts shown in the drawings are not drawn in accordance with the actual scale.

It is noted in the description of this disclosure that the circuits, electronic components, and modules involved in this disclosure are all existing technologies and can be fully implemented by those skilled in the art, without further explanation.

It is further noted that unless otherwise clearly specified and limited, the terms “mount” and “connection” are to be broadly understood. For example, they can be a fixed connection, a detachable connection, or an integrated connection; they can be a mechanical connection or an electrical connection; they can be directly connected, indirectly connected through an intermediate medium, or internally communicated between two elements. For those skilled in the art, the specific meanings of the above terms in this disclosure can be understood according to specific situations.

### Embodiment 1

The embodiment of the present disclosure provides a rolling gear rack mechanism with tooth profile having hyperbolic tooth line structure based on a parabolic function, and the rolling gear rack mechanism includes a gear 5 and a rack 6. An end face tooth profile of the gear 5 and an end face tooth profile of the rack 6 are composed of an end face working tooth profile curve 13 and a tooth root transition curve 12, and the end face tooth profile of the gear 5 and the end face tooth profile of rack 6 are both symmetrical left and right. The end face working tooth profile curve 13 of the gear 5 and the end face working tooth profile curve 13 of the rack 6 are parabolic, and a tooth surface of the gear 5 and a tooth surface of the rack 6 have a hyperbolic tooth line structure. At least one pair of gear teeth meshing points of the gear 5 and the rack 6 are located at nodes to achieve rolling meshing contact, and a meshing line formed by moving trajectories of the meshing points of the gear 5 and the rack 6 respectively forms a contact line on the tooth surface of the gear 5 and the tooth surface of the rack 6, i.e., a gear contact line 10 and a rack contact line 11. The gear contact line 10 is a curve having a hyperbolic line shape after being unfolded along a pitch cylinder 8, the rack contact line 11 is a curve having a hyperbolic line shape after being unfolded along a rack pitch plane 9, and the tooth surface of the gear 5 and the tooth surface of the rack 6 are both formed by regular sweeping of the end face tooth profile along the contact line (i.e., the gear contact line 10 and the rack contact line 11).

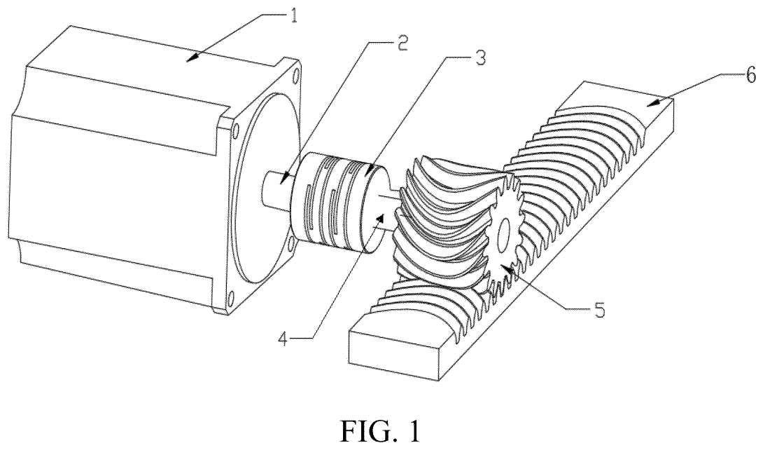

Referring to FIG. 1, in an example rolling gear rack mechanism with tooth profile having hyperbolic tooth line structure based on a parabolic function provided in at least one embodiment of the present disclosure, the contact ratio of the gear 5 and the rack 6 is ε=1.6, the gear 5 and the rack 6 form a pair of gear and rack pairs; the gear 5 is connected to an output shaft 4, an input shaft 2 is fixedly connected to the output shaft 4 through the coupling 3, the input shaft 2 is fixedly connected to a driver 1, and the rack 6 is connected to a driven load.

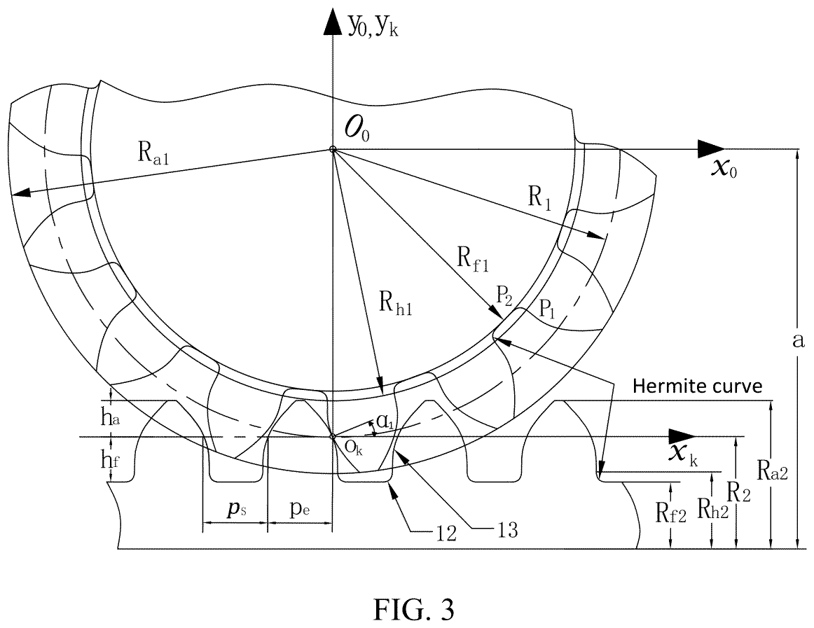

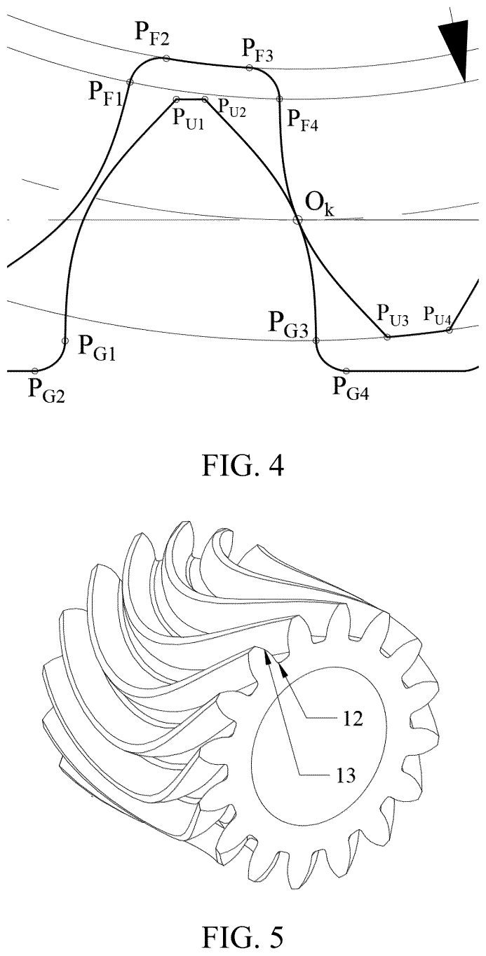

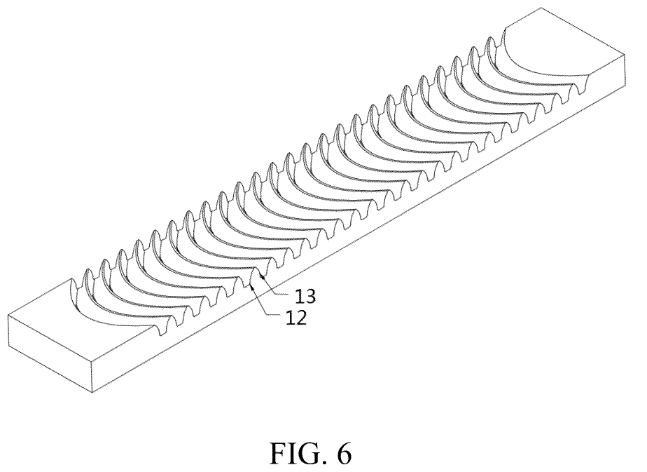

Referring to FIGS. 1-6, the pitch cylinder 8 of the gear has a radius of R₁, a tooth top circle of the rack 6 has a radius of Rₐ₁, and a tooth root circle of the rack 6 has a radius of R_{f1}. The outer surface of the tooth root cylinder of the gear is uniformly arranged with gear teeth with a hyperbolic tooth line structure. The gear contact line 10 is an axisymmetric hyperbola after being unfolded along the pitch cylinder of the gear. The rack contact line 11 is an axisymmetric hyperbola after being unfolded along the rack pitch plane 9. The tooth profile of the end face of the gear consists of a parabola 11 and a tooth root transition curve 12 on the left end face (i.e., a Hermite curve).

In the example rolling gear rack mechanism with tooth profile having hyperbolic tooth line structure based on a parabolic function, the tooth profile of the gear and the tooth profile of the rack are both tooth profiles established based on a parabolic function, and the tooth root of the gear and the tooth root of the rack use a Hermite curve to enhance the bending strength of the tooth root, thereby making the gear less likely to break at the tooth root and enhancing the service life of the gear and rack.

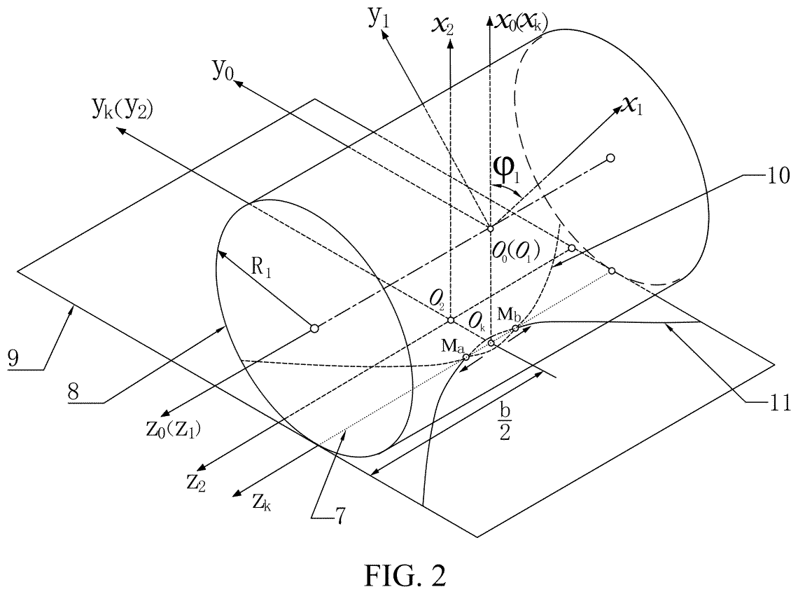

Referring to FIG. 2, the present disclosure provides a schematic diagram of a spatial meshing coordinate system of the rolling gear rack mechanism with tooth profile having hyperbolic tooth line structure based on a parabolic function. The end face working tooth profile of the gear 5 and the end face working tooth profile of the rack 6, as well as a tooth root transition fillet of the gear 5 and a tooth root transition fillet of the rack 6 are symmetrical left and right. The tooth profile on the left side of the end face is obtained symmetrically from the tooth profile on the right side of the end face, and similarly, the left tooth root transition fillet can be obtained symmetrically from the right tooth root transition fillet. A tooth top control point P_{U3} of the working tooth profile on the right end face of the gear 5 is determined by the intersection of the tooth top circle radius Rₐ₁ and the end face working tooth profile; a tooth root transition starting control point P_{F3} of the working tooth profile on the right end face of the gear 5 is determined by the intersection of the tooth root transition starting circle radius Rₕ₁ and the end face working tooth profile; and a tooth root control point P_{F4} of the tooth root transition curve 12 on the right end face of the gear 5 is determined by the intersection of the tooth root circle radius and an oblique line passing through the point P_{F3} with a slope of 1. Similarly, the tooth top control point P_{U2} of the working tooth profile on the right end face of the rack 6 is determined by the intersection of the tooth top position length Rₐ₂ of the rack 6 and the end face working tooth profile; a tooth root transition starting control point P_{G3} of the working tooth profile on the right end face of the rack 6 is determined by the intersection of the tooth root transition starting position length Rₕ₂ of the rack 6 and the end face working tooth profile; and a tooth root control point P_{G4} of the tooth root transition curve 12 on the right end face of the rack 6 is determined by the intersection of the tooth root transition starting position length Rₕ₂ and an oblique line passing through the point P_{G3} with a slope of 1.

The gear 5 rotates under the drive of the driver 1 to make the rack 6 move in translation, thereby realizing the motion and power transmission between the gear 5 and the rack 6. In this embodiment, the driver 1 is an electric motor.

The contact line of the gear 5 and the contact line of the rack 6, i.e., the gear contact line 10 and the rack contact line 11 are determined according to the following methods.

Four spatial coordinate systems O₀-x₀, y₀, z₀, Oₖ-xₖ, yₖ, zₖ, O₁-x₁, y₁, z₁ and O₂-x₂, y₂, z₂, are established. A z₀ axis and a z axis coincide with a rotary axis of the gear 5, a zₖ axis coincides with the meshing line of the gear 5 and the meshing line of the rack 6, a z₂ axis is on the rack 6 and is at a distance of φ₁R₁ from the zₖ axis, and distance between the zₖ axis and the z₀ axis is R₁. The coordinate system O₀-x₀, y₀, z₀ is fixedly connected to the gear 5, and the coordinate system O₂-x₂, y₂, z₂ is fixedly connected to the rack 6. The gear 5 rotates around the z₀ axis at a uniform angular velocity ω₁, and the rack 6 moves along a y₂ axis at a uniform linear velocity v₁. After a period of time from a starting position, the coordinate system O₀-x₀, y₀, z₀ rotates with the gear 5 around the z₀ axis, and the coordinate system O₂-x₂, y₂, z₂ moves with the rack 6 along the y₂ axis.

In the coordinate system Oₖ-xₖ, yₖ, zₖ, a parametric equation of the meshing line 7 of the meshing point motion of the gear 5 and the rack 6 is set as:

$$\{ \begin{matrix}{x}_{k} = 0 & \\ {y}_{k} = 0 & \\ {z}_{k} = \pm b \sqrt{{( \frac{x}{Δ x} + 1 + \sqrt{2} )}^{2} / {( 1 + \sqrt{2} )}^{2} - 1} , & 0 \leq x \leq Δ x\end{matrix} \qquad ( 1 )$$

The relationship between a rotation angle of the gear 5 and a motion of the rack 6 is:

$$\{ \begin{matrix}{φ}_{1} = {k}_{φ} x \\ {v}_{2} = {ω}_{1} {R}_{1}\end{matrix} \qquad ( 2 )$$

When the meshing point M move along the meshing line 7, the gear contact line 10 and the rack contact line 11 are formed on the tooth surface of the gear 5 and the tooth surface of the rack 6, respectively. According to the principle of coordinate transformation, the coordinate transformation matrix for forming the three spatial coordinate systems O₀-x₀, y₀, z₀, O₁-x₁, y₁, z₁ and O₂-x₂, y₂, z₂ is:

$${M}_{1 k} = {M}_{10} \times {M}_{0 k} \qquad ( 3 )$$

In the matrix:

$${M}_{2 k} = [ \begin{matrix}1 & 0 & 0 & 0 \\ 0 & 1 & 0 & - {φ}_{1} {R}_{1} \\ 0 & 0 & 1 & 0 \\ 0 & 0 & 0 & 1\end{matrix} ] \qquad ( 4 )$$

$${M}_{10} = [ \begin{matrix}cos {φ}_{1} & - sin {φ}_{1} & 0 & 0 \\ sin {φ}_{1} & cos {φ}_{1} & 0 & 0 \\ 0 & 0 & 1 & 0 \\ 0 & 0 & 0 & 1\end{matrix} ] \qquad ( 5 )$$

$${M}_{0 k} = [ \begin{matrix}1 & 0 & 0 & {R}_{1} \\ 0 & 1 & 0 & 0 \\ 0 & 0 & 1 & 0 \\ 0 & 0 & 0 & 1\end{matrix} ] \qquad ( 6 )$$

In equations (4) and (6), R₁ is a pitch circle radius of the gear 5, and φ₁ is a rotation angle of the gear 5.

A parametric equation of the gear contact line 10 of the tooth surface of the gear 5 is obtained from equations (1) and (5) as follows:

$$\{ \begin{matrix}{x}_{1} = {R}_{1} cos {φ}_{1} \\ {y}_{1} = {R}_{1} sin {φ}_{1} \\ {z}_{1} = {z}_{k} ( x )\end{matrix} \qquad ( 7 )$$

A parametric equation of the rack contact line 11 of the tooth surface of the rack 6 is obtained from equations (1) and (4) as follows:

$$\{ \begin{matrix}{x}_{1} = 0 \\ {y}_{1} = - {φ}_{1} {R}_{1} \\ {z}_{1} = {z}_{k} ( x )\end{matrix} \qquad ( 8 )$$

Further, the end face tooth profile of the gear 5 and the end face tooth profile of the rack 6 are determined according to the following methods.

In the coordinate system Oₖ-xₖ, yₖ, zₖ, the working tooth profile on the right side of the gear 5 is determined by a parametric equation (9):

$$\{ \begin{matrix}{x}_{k}^{l 1 r} = t cos {α}_{t} + p {t}^{2} sin {α}_{t} \\ {y}_{k}^{l 1 r} = t sin {α}_{t} - p {t}^{2} cos {α}_{t} \\ {z}_{k}^{l 1 r} = 0\end{matrix} \qquad ( 9 )$$

In the coordinate system Oₖ-xₖ, yₖ, zₖ, the working tooth profile on the right side of the rack 6 is determined by a parametric equation (10):

$$\{ \begin{matrix}{x}_{k}^{l 2 r} = t cos {α}_{t} - p {t}^{2} sin {α}_{t} \\ {y}_{k}^{l 2 r} = t sin {α}_{t} + p {t}^{2} cos {α}_{t} \\ {z}_{k}^{l 2 r} = 0\end{matrix} \qquad ( 10 )$$

In the coordinate system Oₖ-xₖ, yₖ, zₖ, the working tooth profile on the left side of the rack 6 is determined by a parametric equation (11):

$$\{ \begin{matrix}{x}_{k}^{l 2 l} = t cos {α}_{t} - p {t}^{2} sin {α}_{t} \\ {y}_{k}^{l 2 l} = - t sin {α}_{t} - p {t}^{2} cos {α}_{t} + \frac{{R}_{1} π}{{z}_{2}} \\ {z}_{k}^{l 2 l} = 0\end{matrix} \qquad ( 11 )$$

In the coordinate system O₁-x₁, y₁, z₁, the working tooth profile on the right side of the gear 5 is determined by a parametric equation (12):

$$\{ \begin{matrix}{x}_{1}^{l 1 r} = t cos {α}_{t} + p {t}^{2} sin {α}_{t} + {R}_{1} \\ {y}_{1}^{l 1 r} = t sin {α}_{t} - p {t}^{2} cos {α}_{t} \\ {z}_{1}^{l 1 r} = 0\end{matrix} \qquad ( 12 )$$

In the coordinate system O₁-x₁, y₁, z₁, the working tooth profile on the left side of the gear 5 is determined by a parametric equation (13):

$$\{ \begin{matrix}{x}_{1}^{l 1 l} = cos \frac{π}{{z}_{1}} {x}_{1}^{l 1 r} + sin \frac{π}{{z}_{1}} {y}_{1}^{l 1 r} \\ {y}_{1}^{l 1 l} = sin \frac{π}{{z}_{1}} {x}_{1}^{l 1 r} - cos \frac{π}{{z}_{1}} {y}_{1}^{l 1 r} \\ {z}_{1}^{l 1 l} = 0\end{matrix} \qquad ( 13 )$$

Further, the tooth surface of the gear 5 and the tooth surface of the rack 6 are determined according to the following methods.

The tooth surface of the gear 5 is formed by regular sweeping along the meshing point M. The working tooth surface on the left side of the gear 5 is determined by a parametric equation (14):

$$\{ \begin{matrix}{X}_{1}^{l 1 l} = {x}_{1}^{l 1 l} cos ( {k}_{φ} x ) - {y}_{1}^{l 1 l} sin ( {k}_{φ} x ) \\ {Y}_{1}^{l 1 l} = {x}_{1}^{l 1 l} sin ( {k}_{φ} x ) + {y}_{1}^{l 1 l} cos ( {k}_{φ} x ) \\ {Z}_{1}^{l 1 l} = \pm b \sqrt{{( \frac{x}{Δ x} + 1 + \sqrt{2} )}^{2} / {( 1 + \sqrt{2} )}^{2} - 1}\end{matrix} \qquad ( 14 )$$

The working tooth surface on the right side of the gear 5 is determined by a parametric equation (15):

$$\{ \begin{matrix}{X}_{1}^{l 1 r} = {x}_{1}^{l 1 r} cos ( {k}_{φ} x ) - {y}_{1}^{l 1 r} sin ( {k}_{φ} x ) \\ {Y}_{1}^{l 1 r} = {x}_{1}^{l 1 r} sin ( {k}_{φ} x ) + {y}_{1}^{l 1 r} cos ( {k}_{φ} x ) \\ {Z}_{1}^{l 1 r} = \pm b \sqrt{{( \frac{x}{Δ x} + 1 + \sqrt{2} )}^{2} / {( 1 + \sqrt{2} )}^{2} - 1}\end{matrix} \qquad ( 15 )$$

The tooth surface of the rack 6 is formed by along moving trajectories of the rack contact line. The working tooth surface on the left side of the rack 6 is determined by a parametric equation (16):

$$\{ \begin{matrix}{X}_{2}^{l 2 l} = {x}_{k}^{l 2 l} \\ {Y}_{2}^{l 2 l} = {y}_{k}^{l 2 l} - {R}_{1} ( {k}_{φ} x ) \\ {Z}_{2}^{l 2 l} = \pm b \sqrt{{( \frac{x}{Δ x} + 1 + \sqrt{2} )}^{2} / {( 1 + \sqrt{2} )}^{2} - 1}\end{matrix} \qquad ( 16 )$$

The working tooth surface on the right side of the rack 6 is determined by a parametric equation (17):

$$\{ \begin{matrix}{X}_{2}^{l 2 r} = {x}_{k}^{l 2 r} \\ {Y}_{2}^{l 2 r} = {y}_{k}^{l 2 r} - {R}_{1} ( {k}_{φ} x ) \\ {Z}_{2}^{l 2 r} = \pm b \sqrt{{( \frac{x}{Δ x} + 1 + \sqrt{2} )}^{2} / {( 1 + \sqrt{2} )}^{2} - 1}\end{matrix} \qquad ( 17 )$$

Further, the tooth root transition curve of the gear 5 and the tooth root transition curve of the rack 6 are determined according to the following methods.

The tooth root on the right side of the end face of the gear 5 uses a Hermite curve as the transition curve. The Hermite curve is determined by points P_{F3} and P_{F4}, as well as T_{F3} and T_{F4}, which are the tangent vectors of points P_{F3} and P_{F4}, respectively. The point P_{F3} is determined by the working tooth profile curve on the right side of the gear 5 and a starting radius Rₕ₁ of a tooth root transition fillet, and the point P_{F4} is determined by a radius R_{f1} of the tooth root circle and an oblique line passing through the point P_{F3} with a slope of 1. The parametric equation for the Hermite curve is:

$$\{ \begin{matrix}{x}_{P 34}^{her} = {b}_{1} {x}_{p} ( {P}_{F 3} ) + {b}_{2} {x}_{p} ( {P}_{F 4} ) + {T}_{H} {m}_{t} [ {b}_{3} {x}_{p} ( {T}_{F 3} ) + {b}_{4} {x}_{p} ( {T}_{F 4} ) ] \\ {y}_{P 34}^{her} = {b}_{1} {y}_{p} ( {P}_{F 3} ) + {b}_{2} {y}_{p} ( {P}_{F 4} ) + {T}_{H} {m}_{t} [ {b}_{3} {y}_{p} ( {T}_{F 3} ) + {b}_{4} {y}_{p} ( {T}_{F 4} ) ] \\ {z}_{P 34}^{her} = {b}_{1} {z}_{p} ( {P}_{F 3} ) + {b}_{2} {z}_{p} ( {P}_{F 4} ) + {T}_{H} {m}_{t} [ {b}_{3} {z}_{p} ( {T}_{F 3} ) + {b}_{4} {z}_{p} ( {T}_{F 4} ) ]\end{matrix} \qquad ( 18 )$$

The tooth root on the right side of the end face of the rack 6 uses a Hermite curve as the transition curve. The Hermite curve is determined by points P_{G3} and P_{G4}, as well as TGs and T_{G4}, which are the tangent vectors of points P_{G3} and P_{G4}, respectively. The point P_{G3} is determined by the working tooth profile curve on the right side of the gear 5 and a starting radius Rₕ₂ of a tooth root transition fillet, and the point P_{G4} is determined by a radius R_{f2} of the tooth root circle and an oblique line passing through the point P_{G3} with a slope of 1. The parametric equation for the Hermite curve is:

$$\{ \begin{matrix}{x}_{G 34}^{her} = {b}_{1} {x}_{G} ( {P}_{G 3} ) + {b}_{2} {x}_{G} ( {P}_{G 4} ) + {T}_{H} {m}_{t} [ {b}_{3} {x}_{G} ( {T}_{G 3} ) + {b}_{4} {x}_{G} ( {T}_{G 4} ) ] \\ {y}_{G 34}^{her} = {b}_{1} {y}_{G} ( {P}_{G 3} ) + {b}_{2} {y}_{G} ( {P}_{G 4} ) + {T}_{H} {m}_{t} [ {b}_{3} {y}_{G} ( {T}_{G 3} ) + {b}_{4} {y}_{G} ( {T}_{G 4} ) ] \\ {z}_{G 34}^{her} = {b}_{1} {z}_{G} ( {P}_{G 3} ) + {b}_{2} {z}_{G} ( {P}_{G 4} ) + {T}_{H} {m}_{t} [ {b}_{3} {z}_{G} ( {T}_{G 3} ) + {b}_{4} {z}_{G} ( {T}_{G 4} ) ]\end{matrix} \qquad ( 19 )$$

In the parametric equation:

$$\{ \begin{matrix}{b}_{1} = 2 {t}_{H}^{3} - 3 {t}_{H}^{2} + 1 \\ {b}_{2} = - 2 {t}_{H}^{3} + 3 {t}_{H}^{2} \\ {b}_{3} = {t}_{H}^{3} - 2 {t}_{H}^{2} + {t}_{H} \\ {b}_{4} = {t}_{H}^{3} - {t}_{H}^{2}\end{matrix} \qquad ( 20 )$$

In all the above formulas:

p is a parabola parameter; x is a motion parameter variable of the meshing point M, and x∈[0, Δx]; Δx is the maximum value of the motion parameter variable of the meshing point; k_{φ} is a linear scale coefficient of the motion of the meshing point; i is contact ratio; mₜ is a modulus of the end face; Z₁ is the number of gear teeth; Z₂ is the number of teeth passing through the rack after one revolution of the gear; T_{H} is a Hermite type line parameter, 0.2≤T_{H}≤1.5; t_{H} is a value range of Hermite type lines, 0≤t_{H}≤1; P_{F3} is an intersection point between the starting radius of the gear transition fillet and the working tooth profile parameter equation of the gear; P_{F4} is an intersection point of the radius of the tooth root circle and the oblique line passing through the point P_{F3} with a slope of 1; P_{G3} is an intersection point between the starting length of the transition fillet of the rack and the parameter equation of the working tooth profile of the rack; P_{G4} is an intersection point of the length of the tooth root position of the rack and the oblique line passing through the point P_{G3} with a slope of 1; T_{P1} is an unit tangent vector for point P₁; T_{P2} is an unit tangent vector for point P₂; T_{G1} is an unit tangent vector for point G₁; T_{G2} is an unit tangent vector for point G₂; xₚ(P_{F3}) is the x coordinates of the point P_{F3}; yₚ(P_{F3}) is the y coordinates of the point P_{F3}; z_{y}(P_{F3}) is the z coordinates of the point P_{F3}; xₚ (P_{F4}) is the x coordinates of the point P_{F4}; yₚ(P_{F4}) is the y coordinates of the point P_{F4}; zₚ(P_{F4}) is the z coordinates of the point P_{F4}; x_{G}(P_{G3}) is the x coordinates of the point P_{G3}; y_{G}(P_{G3}) is the y coordinates of the point P_{G3}; z_{G}(P_{G3}) is the z coordinates of the point P_{G3}; x_{G}(P_{G4}) is the x coordinates of the point P_{G4}; y_{G}(P_{G4}) is the y coordinates of the point P_{G4}; z_{G}(P_{G4}) is the z coordinates of the point P_{G4}; Δd is a face width coefficient; b is a width of the gear teeth, and b=Δd×2R₁ (21); αₜ is an end pressure angle, αₜ=20°;

$${h}_{a n}^{*}$$

is a tooth top height coefficient,

$${h}_{a n}^{*} = 1 ; {c}_{n}^{*}$$

is a top clearance coefficient,

$${c}_{n}^{*} = 0.25 ;$$

R₁ is a pitch circle radius of the gear, and R₁=mₜZ₁/2 (22); R₂ is a pitch line of the rack; a is a center distance between rack and gear, and a=R₁+R₂ (23); hₐ is a height of the tooth top, and

$${h}_{a} = {h}_{a n}^{*} {m}_{t} ; \qquad ( 24 )$$

h_{f} is a height of the tooth root, and

$${h}_{f} = ( {h}_{a n}^{*} + {c}_{n}^{*} ) {m}_{t} ; \qquad ( 25 )$$

Rₐ₁ is a radius of the tooth top circle of the gear, and Rₐ₁=R₁+hₐ (26); R_{f1} is a radius of the tooth root circle of the gear, and R_{f1}=R₁−h_{f} (27); Rₕ₁ is a starting radius of the transition fillet of the gear, and Rₕ₁=R₁−hₐ (28); Rₐ₂ is a length of the tooth top position of the rack, and Rₐ₂=R₂+hₐ (29); R_{f2} is a length of the tooth root position of the rack, and R_{f2}=R₂−h_{f} (30); Rₕ₂ is a starting length of the rack transition fillet, and Rₕ₂=R₂−hₐ (31); ε is the contact ratio, and

$$ε = \frac{{Z}_{1} Δ t}{2} ; \qquad ( 32 )$$

pₜ is a transverse pitch, and pₜ=πmₜ (33).

The relevant parameters are taken as Z₁=16, i=1, mₜ=2, k_{φ}=π, b=32 mm, and αₜ=20°, and the results are Δx=0.2, R₁=16 mm, R₂=38 mm.

Then, by substituting the above values into equation (1)-equation (33), the contact line parameter equation of the gear and rack and the parameter equation of the end face tooth profile of the gear and rack in this example can be obtained, and the tooth surface structure of the gear and rack can be obtained, and the gear rack mechanism can be assembled according to the correct center distance.

### Embodiment 2

In the rolling gear rack mechanism with tooth profile having hyperbolic tooth line structure based on a parabolic function, the contact ratio of a gear can be freely designed, and the structural shape of the tooth profile can be determined by setting the contact ratio value, to evenly distribute the load and improve dynamic characteristics.

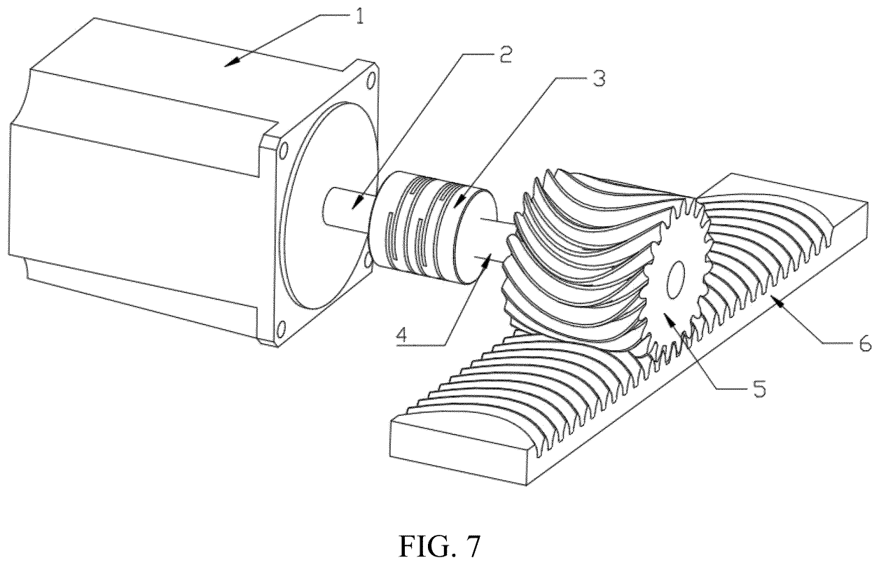

As shown in FIG. 7, this embodiment of the present disclosure also provides another rolling gear rack mechanism with tooth profile having hyperbolic tooth line structure based on a parabolic function. In the gear rack mechanism, a gear 5 is connected with an output shaft 4, the output shaft 4 is connected with an input shaft 2 through a coupling 3, the input shaft 2 is fixedly connected with a driver 1, and a rack 6 is connected with a driven load. In this embodiment, the number of teeth of the gear 5 is 20. The number of teeth of the rack 6 is 30, and the contact ratio is set to ε=2. When the output shaft 4 drives the gear 5 to rotate, since two pairs of adjacent gear teeth are in a meshed state when installing the gear 5 and the rack 6, the preset contact ratio, which is of the rolling gear rack mechanism with tooth profile having hyperbolic tooth line structure based on a parabolic function, is set to ε=2, thus ensuring that at least two pairs of gear teeth simultaneously participate in meshing transmission at each instant. Thus, continuous and stable meshing transmission of the rolling gear rack mechanism with tooth profile having hyperbolic tooth line structure based on a parabolic function is realized in rotating motion.

The relevant parameters are taken as Z₁=20, i=1, mₜ=2, ε=2, k_{φ}=π, b=40 mm, and αₜ=20°, and the results are Δx=0.2, R₁=20 mm, R₂=38 mm.

By substituting the above values into equation (1)-equation (33), the contact line parameter equation of the gear and rack and the parameter equation of the end face tooth profile of the gear and rack in this example can be obtained. Then, according to the motion law of the meshing point, the rolling gear rack mechanism with tooth profile having hyperbolic tooth line structure based on a parabolic function can be obtained, and can be assembled according to the correct center distance.

In the context, the directional terms such as front, back, top, and bottom are defined based on the locations of the parts in the drawings and the positions of the parts between each other, just for the clarity and convenience of expressing the technical solution. It will be understood that they are relative concepts that can change accordingly according to different ways of use and placement, and the use of the directional terms should not limit the scope of protection claimed in this application.

The above embodiments and features in the embodiments herein may be combined with each other without conflict. The above are only preferred embodiments of the disclosure and are not used to limit the disclosure. Any modifications, equivalent substitutions, improvements, etc. made within the spirit and principles of the disclosure should be included within the scope of protection of the disclosure.

1. A rolling gear rack mechanism with tooth profile having hyperbolic tooth line structure based on a parabolic function, comprising:
a gear, and
a rack, wherein
an end face tooth profile of the gear and an end face tooth profile of the rack are composed of an end face working tooth profile curve and a tooth root transition curve, and the end face tooth profile of the gear and the end face tooth profile of rack are both symmetrical left and right;
the end face working tooth profile curve of the gear and the end face working tooth profile curve of the rack are parabolic, and a tooth surface of the gear and a tooth surface of the rack have a hyperbolic tooth line structure; and at least one pair of gear teeth meshing points of the gear and the rack are located at nodes to achieve rolling meshing contact, and a meshing line formed by moving trajectories of the meshing points of the gear and the rack forms a gear contact line and a rack contact line on the tooth surface of the gear and the tooth surface of the rack respectively.

2. The rolling gear rack mechanism of claim 1, wherein the gear contact line is a curve having a hyperbolic line shape in a case that the gear contact line is unfolded along a pitch cylinder, and the rack contact line is a curve having a hyperbolic line shape in a case that the rack contact line is unfolded along a pitch plane; and the tooth surface of the gear is formed by regular sweeping of the end face tooth profile of the gear along the gear contact line, and the tooth surface of the rack is formed by regular sweeping of the end face tooth profile of the rack along the rack contact line.

3. The rolling gear rack mechanism of claim 1, wherein the working tooth profile curve on the right side of the gear and the working tooth profile curve on the right side of the rack are both formed by parabolas, and the tooth root transition curve of the gear is composed of a Hermite curve; a value range of the end face working tooth profile curve is configured to control a starting point and an ending point of the working tooth profile curve according to specific control points; a tooth top control point of the gear is determined by an intersection point of a tooth top circle and a parabolic curve, a starting control point of the tooth root transition curve is determined by an intersection point P_{G4} of the parabolic curve and a tooth root transition starting circle, and a contact control point of the tooth root transition curve is determined by an intersection point P_{G3} of a tooth root circle and an oblique line passing through the point P_{G4} with a slope of 1; and the point P_{G4} and the point P_{G3} are connected according to a Hermite curve equation to form a tooth root curve.

4. The rolling gear rack mechanism of claim 1, wherein the gear contact line and the rack contact line are determined according to following methods:
establishing four spatial coordinate systems O₀-x₀, y₀, z₀, Oₖ-xₖ, yₖ, zₖ, O₁-x₁, y₁, z₁ and O₂-x₂, y₂, z₂;
wherein:
a z₀ axis and a z₁ axis coincide with a rotary axis of the gear, a zₖ axis coincides with the meshing line of the gear and the meshing line of the rack, a z₂ axis is on the rack and is at a distance of φ₁R₁ from the zₖ axis, and distance between the zₖ axis and the z₀ axis is R_{y}; the coordinate system O₀-x₀, y₀, z₀ is fixedly connected to the gear, and the coordinate system O₂-x₂, y₂, z₂ is fixedly connected to the rack; the gear rotates around the z₀ axis at a uniform angular velocity ω₁, and the rack moves along a y₂ axis at a uniform linear velocity v₁; and after a period of time from a starting position, the coordinate system O₀-x₀, y₀, z₀ rotates with the gear around the z₀ axis, and the coordinate system O₂-x₂, y₂, z₂ moves with the rack along the y₂ axis;
in the coordinate system Oₖ-xₖ, yₖ, zₖ, a parametric equation of the meshing line of the meshing point motion of the gear and the rack is set as:
$$\{ \begin{matrix}{x}_{k} = 0 \\ {y}_{k} = 0 \\ {z}_{k} = \pm b \sqrt{{( \frac{x}{Δ x} + 1 + \sqrt{2} )}^{2} / {( 1 + \sqrt{2} )}^{2} - 1} , 0 \leq x \leq Δ x\end{matrix} \qquad ( 1 )$$
the relationship between a rotation angle of the gear and a motion of the rack is:
$$\{ \begin{matrix}{φ}_{1} = {k}_{φ} x \\ {v}_{2} = {ω}_{1} {R}_{1}\end{matrix} \qquad ( 2 )$$
in a case that the meshing points move along the meshing line, the gear contact line and the rack contact line are formed on the tooth surface of the gear and the tooth surface of the rack, respectively; and according to the principle of coordinate transformation, the coordinate transformation matrix for forming the three spatial coordinate systems O₀-x₀, y₀, z₀, O₁-x₁, y₁, z₁ and O₂-x₂, y₂, z₂ is:
$${M}_{1 k} = {M}_{10} \times {M}_{0 k} \qquad ( 3 )$$
wherein:
$${M}_{2 k} = [ \begin{matrix}1 & 0 & 0 & 0 \\ 0 & 1 & 0 & - {φ}_{1} {R}_{1} \\ 0 & 0 & 1 & 0 \\ 0 & 0 & 0 & 1\end{matrix} ] \qquad ( 4 )$$
$${M}_{10} = [ \begin{matrix}cos {φ}_{1} & - s in {φ}_{1} & 0 & 0 \\ sin {φ}_{1} & cos {φ}_{1} & 0 & 0 \\ 0 & 0 & 1 & 0 \\ 0 & 0 & 0 & 1\end{matrix} ] \qquad ( 5 )$$
$${M}_{0 k} = [ \begin{matrix}1 & 0 & 0 & {R}_{1} \\ 0 & 1 & 0 & 0 \\ 0 & 0 & 1 & 0 \\ 0 & 0 & 0 & 1\end{matrix} ] \qquad ( 6 )$$
in equations (4) and (6), R₁ is a pitch circle radius of the gear, and φ₁ is a rotation angle of the gear;
a parametric equation of the gear contact line of the tooth surface of the gear is obtained from equations (1) and (5) as follows:
$$\{ \begin{matrix}{x}_{1} = {R}_{1} cos {φ}_{1} \\ {y}_{1} = {R}_{1} sin {φ}_{1} \\ {z}_{1} = {z}_{k} ( x )\end{matrix} , \qquad ( 7 )$$
and
a parametric equation of the rack contact line of the tooth surface of the rack is obtained from equations (1) and (4) as follows:
$$\{ \begin{matrix}{x}_{1} = 0 \\ {y}_{1} = - {φ}_{1} {R}_{1} \\ {z}_{1} = {z}_{k} ( x )\end{matrix} . \qquad ( 8 )$$

5. The rolling gear rack mechanism of claim 4, wherein the end face tooth profile of the gear and the end face tooth profile of the rack are determined according to following methods:
in the coordinate system Oₖ-xₖ, yₖ, zₖ, determining the working tooth profile on the right side of the gear by a parametric equation (9):
$$\{ \begin{matrix}{x}_{k}^{l 1 r} = t cos {α}_{t} + p {t}^{2} sin {α}_{t} \\ {y}_{k}^{l 1 r} = {t sin α}_{t} - p {t}^{2} cos {α}_{t} \\ {z}_{k}^{l 1 r} = 0\end{matrix} \qquad ( 9 )$$
in the coordinate system Oₖ-xₖ, yₖ, zₖ, determining the working tooth profile on the right side of the rack by a parametric equation (10):
$$\{ \begin{matrix}{x}_{k}^{l 2 r} = t cos {α}_{t} - p {t}^{2} sin {α}_{t} \\ {y}_{k}^{l 2 r} = tsin {α}_{t} + p {t}^{2} cos {α}_{t} \\ {z}_{k}^{l 2 r} = 0\end{matrix} \qquad ( 10 )$$
in the coordinate system Oₖ-xₖ, yₖ, zₖ, determining the working tooth profile on the left side of the rack by a parametric equation (11):
$$\{ \begin{matrix}{x}_{k}^{l 2 l} = t cos {α}_{t} - p {t}^{2} sin {α}_{t} \\ {y}_{k}^{l 2 l} = - t sin {α}_{t} - p {t}^{2} cos {α}_{t} + \frac{{R}_{1} π}{{z}_{2}} \\ {z}_{k}^{l 2 l} = 0\end{matrix} \qquad ( 11 )$$
in the coordinate system O₁-x₁, y₁, z₁, determining the working tooth profile on the right side of the gear by a parametric equation (12):
$$\{ \begin{matrix}{x}_{1}^{l 1 r} = t cos {α}_{t} + p {t}^{2} sin {α}_{t} + {R}_{1} \\ {y}_{1}^{l 1 r} = t sin {α}_{t} - p {t}^{2} cos {α}_{t} \\ {z}_{1}^{l 1 r} = 0\end{matrix} , \qquad ( 12 )$$
and
in the coordinate system O₁-x₁, y₁, z₁, determining the working tooth profile on the left side of the gear by a parametric equation (13):
$$\{ \begin{matrix}{x}_{1}^{l 1 l} = cos \frac{π}{{z}_{1}} {x}_{1}^{l 1 r} + sin \frac{π}{{z}_{1}} {y}_{1}^{l 1 r} \\ {y}_{1}^{l 1 l} = sin \frac{π}{{z}_{1}} {x}_{1}^{l 1 r} - cos \frac{π}{{z}_{1}} {y}_{1}^{l 1 r} \\ {z}_{1}^{l 1 l} = 0\end{matrix} . \qquad ( 13 )$$

6. The rolling gear rack mechanism of claim 5, wherein the tooth surface of the gear and the tooth surface of the rack are determined according to following methods:
forming the tooth surface of the gear by regular sweeping along the meshing point M, and determining the working tooth surface on the left side of the gear by a parametric equation (14):
$$\{ \begin{matrix}{X}_{1}^{l 1 l} = {x}_{1}^{l 1 l} cos ( {k}_{φ} x ) - {y}_{1}^{l 1 l} sin ( {k}_{φ} x ) \\ {Y}_{1}^{l 1 l} = {x}_{1}^{l 1 l} sin ( {k}_{φ} x ) + {y}_{1}^{l 1 l} cos ( {k}_{φ} x ) \\ {Z}_{1}^{l 1 l} = \pm b \sqrt{{( \frac{x}{Δ x} + 1 + \sqrt{2} )}^{2} / {( 1 + \sqrt{2} )}^{2} - 1}\end{matrix} \qquad ( 14 )$$
determining the working tooth surface on the right side of the gear by a parametric equation (15):
$$\{ \begin{matrix}{X}_{1}^{l 1 r} = {x}_{1}^{l 1 r} cos ( {k}_{φ} x ) - {y}_{1}^{l 1 r} sin ( {k}_{φ} x ) \\ {Y}_{1}^{l 1 r} = {x}_{1}^{l 1 r} sin ( {k}_{φ} x ) + {y}_{1}^{l 1 r} cos ( {k}_{φ} x ) \\ {Z}_{1}^{l 1 r} = \pm b \sqrt{{( \frac{x}{Δ x} + 1 + \sqrt{2} )}^{2} / {( 1 + \sqrt{2} )}^{2} - 1}\end{matrix} \qquad ( 15 )$$
forming the tooth surface of the rack is formed by along moving trajectories of the rack contact line, and determining the working tooth surface on the left side of the rack by a parametric equation (16):
$$\{ \begin{matrix}{X}_{2}^{l 2 l} = {x}_{k}^{l 2 l} \\ {Y}_{2}^{l 2 l} = {y}_{k}^{l 2 l} - {R}_{1} ( {k}_{φ} x ) \\ {Z}_{2}^{l 2 l} = \pm b \sqrt{{( \frac{x}{Δ x} + 1 + \sqrt{2} )}^{2} / {( 1 + \sqrt{2} )}^{2} - 1}\end{matrix} \qquad ( 16 )$$
determining the working tooth surface on the right side of the rack by a parametric equation (17):
$$\{ \begin{matrix}{X}_{2}^{l 2 r} = {x}_{k}^{l 2 r} \\ {Y}_{2}^{l 2 r} = {y}_{k}^{l 2 r} - {R}_{1} ( {k}_{φ} x ) \\ {Z}_{2}^{l2r} = \pm b \sqrt{{( \frac{x}{Δ x} + 1 + \sqrt{2} )}^{2} / {( 1 + \sqrt{2} )}^{2} - 1}\end{matrix} . \qquad ( 17 )$$

7. The rolling gear rack mechanism of claim 6, wherein the tooth root transition curve of the gear and the tooth root transition curve of the rack are determined according following methods:
using a Hermite curve as the transition curve for the tooth root on the right side of the end face of the gear; wherein the Hermite curve is determined by points P_{F3} and P_{F4}, as well as T_{F3} and T_{F4}, which are the tangent vectors of points P_{F3} and P_{F4}, respectively; the point P_{F3} is determined by the working tooth profile curve on the right side of the gear and a starting radius Rₕ₁ of a tooth root transition fillet, and the point P_{F4} is determined by a radius Rf of the tooth root circle and an oblique line passing through the point P_{F3} with a slope of 1; and the parametric equation for the Hermite curve is:
$$\{ \begin{matrix}{x}_{P 34}^{her} = {b}_{1} {x}_{p} ( {P}_{F 3} ) + {b}_{2} {x}_{p} ( {P}_{F 4} ) + {T}_{H} {m}_{t} [ {b}_{3} {x}_{p} ( {T}_{F 3} ) + {b}_{4} {x}_{p} ( {T}_{F 4} ) ] \\ {y}_{P 34}^{her} = {b}_{1} {y}_{p} ( {P}_{F 3} ) + {b}_{2} {y}_{p} ( {P}_{F 4} ) + {T}_{H} {m}_{t} [ {b}_{3} {y}_{p} ( {T}_{F 3} ) + {b}_{4} {y}_{p} ( {T}_{F 4} ) ] \\ {z}_{P 34}^{her} = {b}_{1} {z}_{p} ( {P}_{F 3} ) + {b}_{2} {z}_{p} ( {P}_{F 4} ) + {T}_{H} {m}_{t} [ {b}_{3} {z}_{p} ( {T}_{F 3} ) + {b}_{4} {z}_{p} ( {T}_{F 4} ) ]\end{matrix} \qquad ( 18 )$$
using a Hermite curve as the transition curve for the tooth root on the right side of the end face of the rack, wherein the Hermite curve is determined by points P_{G3} and P_{G4}, as well as T_{G3} and T_{G4}, which are the tangent vectors of points P_{G3} and P_{G4}, respectively; the point P_{G3} is determined by the working tooth profile curve on the right side of the gear and a starting radius Rₕ₂ of a tooth root transition fillet, and the point P_{G4} is determined by a radius R_{f2} of the tooth root circle and an oblique line passing through the point P_{G3} with a slope of 1; and the parametric equation for the Hermite curve is:
$$\{ \begin{matrix}{x}_{G 34}^{her} = {b}_{1} {x}_{G} ( {P}_{G 3} ) + {b}_{2} {x}_{G} ( {P}_{G 4} ) + {T}_{H} {m}_{t} [ {b}_{3} {x}_{G} ( {T}_{G 3} ) + {b}_{4} {x}_{G} ( {T}_{G 4} ) ] \\ {y}_{G 34}^{her} = {b}_{1} {y}_{G} ( {P}_{G 3} ) + {b}_{2} {y}_{G} ( {P}_{G 4} ) + {T}_{H} {m}_{t} [ {b}_{3} {y}_{G} ( {T}_{G 3} ) + {b}_{4} {y}_{G} ( {T}_{G 4} ) ] \\ {z}_{G 34}^{her} = {b}_{1} {z}_{G} ( {P}_{G 3} ) + {b}_{2} {z}_{G} ( {P}_{G 4} ) + {T}_{H} {m}_{t} [ {b}_{3} {z}_{G} ( {T}_{G 3} ) + {b}_{4} {z}_{G} ( {T}_{G 4} ) ]\end{matrix} \qquad ( 19 )$$
wherein:
$$\{ \begin{matrix}{b}_{1} = 2 {t}_{H}^{3} - 3 {t}_{H}^{2} + 1 \\ {b}_{2} = - 2 {t}_{H}^{3} + 3 {t}_{H}^{2} \\ {b}_{3} = {t}_{H}^{3} - 2 {t}_{H}^{2} + {t}_{H} \\ {b}_{4} = {t}_{H}^{3} - {t}_{H}^{2}\end{matrix} \qquad ( 20 )$$
in all equations:
p is a parabola parameter; x is a motion parameter variable of the meshing point M, and x∈[0, Δx]; Δx is the maximum value of the motion parameter variable of the meshing point; k_{φ} is a linear scale coefficient of the motion of the meshing point; i is contact ratio; mₜ is a modulus of the end face; Z₁ is the number of gear teeth; Z₂ is the number of teeth passing through the rack after one revolution of the gear; T_{H} is a Hermite type line parameter, 0.2≤T_{H}≤1.5; t_{H} is the value range of Hermite type lines, 0≤t_{H}≤1; P_{F3} is an intersection point between the starting radius of the gear transition fillet and the working tooth profile parameter equation of the gear; P_{F4} is an intersection point of the radius of the tooth root circle and the oblique line passing through the point P_{F3} with a slope of 1; P_{G3} is an intersection point between the starting length of the transition fillet of the rack and the parameter equation of the working tooth profile of the rack; P_{G4} is an intersection point of the length of the tooth root position of the rack and the oblique line passing through the point P_{G3} with a slope of 1; T_{P1} is an unit tangent vector for point P₁; T_{P2} is an unit tangent vector for point P₂; T_{G1} is an unit tangent vector for point G₁; T_{G2} is an unit tangent vector for point G₂; xₚ(P_{F3}) is the x coordinates of the point P_{F3}; yₚ(P_{F3}) is the y coordinates of the point P_{F3}; zₚ(P_{F3}) is the z coordinates of the point P_{F3}; xₚ(P_{F4}) is the x coordinates of the point P_{F4}; yₚ(P_{F4}) is the y coordinates of the point P_{F4}; zₚ(P_{F4}) is the z coordinates of the point P_{F4}; x_{G}(P_{G3}) is the x coordinates of the point P_{G3}; y_{G}(P_{G3}) is the y coordinates of the point P_{G3}; z_{G}(P_{G3}) is the z coordinates of the point P_{G3}; x_{G}(P_{G4}) is the x coordinates of the point P_{G4}; y_{G}(P_{G4}) is the y coordinates of the point P_{G4}; z_{G}(P_{G4}) is the z coordinates of the point P_{G4}; Δd is a face width coefficient; b is a width of the gear teeth, and b=Δd×2R₁ (21); αₜ is an end pressure angle, αₜ=20°;
$${h}_{a n}^{*}$$
is a tooth top height coefficient,
$${h}_{a n}^{*} = 1 ; {c}_{n}^{*}$$
is a top clearance coefficient,
$${c}_{n}^{*} = 0.25 ;$$
R₁ is a pitch circle radius of the gear, and R₁=mₜZ₁/2 (22); R₂ is a pitch line of the rack; a is a center distance between rack and gear, and a=R₁+R₂ (23); hₐ is a height of the tooth top, and
$${h}_{a} = {h}_{a n}^{*} {m}_{t} ; \qquad ( 24 )$$
h_{f} is a height of the tooth root, and
$${h}_{f} = ( {h}_{a n}^{*} + {c}_{n}^{*} ) {m}_{t} ; \qquad ( 25 )$$
Rₐ₁ is a radius of the tooth top circle of the gear, and Rₐ₁=R₁+hₐ (26); R_{f1} is a radius of the tooth root circle of the gear, and R_{f1}=R₁−h_{f} (27); Rₕ₁ is a starting radius of the transition fillet of the gear, and Rₕ₁=R₁−hₐ (28); Rₐ₂ is a length of the tooth top position of the rack, and Rₐ₂=R₂+hₐ (29); R_{f2} is a length of the tooth root position of the rack, and R_{f2}=R₂−h_{f} (30); Rₕ₂ is a starting length of the rack transition fillet, and Rₕ₂=R₂−hₐ (31); ε is the contact ratio, and
$$ε = \frac{{z}_{1} Δ t}{2} ; \qquad ( 32 )$$
pₜ is a transverse pitch, and pₜ=πmₜ (33).
